(19) United States
(12) Patent Application Publication
(10) Pub. No.: US 2008/0052290 A1
(43) Pub. Date: Feb. 28, 2008

(54) Session File Modification With Locking of One or More of Session File Components

(76) Inventors: Jonathan Kahn, Crown Point, IN (US); Michael C. Huttinger, Valparaiso, IN (US)

Correspondence Address: LOEB & LOEB, LLP, 321 NORTH CLARK, SUITE 2300, CHICAGO, IL, 60610-4746, US

(21) Appl. No.: 11/740,774

(22) Filed: Apr. 26, 2007

Related U.S. Application Data
(63) Continuation-in-part of application No. 11/467,445, filed on Aug. 25, 2006.

(51) Int. Cl. G06F 17/30

(52) U.S. Cl. 707/8; 707/E17.007

(57) ABSTRACT

An apparatus comprising a session file and session file editor with main window and one or more document windows and annotation window and lock/unlock features. The session file may include text, audio, image, and other data elements with source data divided into segments or other bounded divisions and other data elements associated to original data. The session file may be derived from processing third-party application output. These applications may run as plugins that load with the session file editor or on a server. The session file editor displays text and other content, provides text selection capability and plays back audio of session files with audio-linked text as embedded content, and supports entry of text. The session file editor supports locking a session file from a such that a locked file cannot be modified and saved by a user with the session file editor.

### CROSS-REFERENCE TO RELATED APPLICATION

This application is a continuation-in-part of U.S. Non-Provisional application Ser. No. 11/464,445, filed Aug. 25, 2006 entitled “Session File Modification With Selective Replacement of Session File Components,” which claims the benefit of U.S. Non-Provisional application Ser. No. 11/279,551, filed Apr. 12, 2006 entitled “Session File Modification with Annotation Using Speech Recognition or Text to Speech,” which claims the benefit of U.S. Non-Provisional application Ser. No. 11/203,671, filed Aug. 12, 2005 entitled “Synchronized Pattern Recognition Source Data Processed by Manual or Automatic Means for Creation of Shared Speaker-Dependent Speech User Profile,” which is still pending (hereinafter referred to as the '671 application). The '671 application and previous copending applications are incorporated herein by reference to the extent permitted by law.

### BACKGROUND OF THE INVENTION

1. Field of the Invention

The present invention relates to electronic document protection.

2. Background Information

An electronic document may be created from a text file to protect against unauthorized editing. One example is the Portable Document Format (.PDF) (Adobe Systems, Inc., San Jose, Calif.) for text and files with a variety of fonts, graphics, colors, and images. This format has been used to protect files from different desktop applications, including text processors such as Word (Microsoft Corporation, Redmond Corporation, WA) or WordPerfect® (Corel Corporation, Ottawa, Canada). Similarly, Microsoft® Word 2000 supports document protection for tracked changes, comments, and forms with an optional password. Various approaches have been developed to limit file modification, including check sum, cyclical redundancy check, polynomials, and pseudo random numbers. Another method is to lock files using a hash function, a small digital identifier derived from any kind of data. Hash functions may include a cryptographic hash function, a security hash table, an associative array, and geometric hashing.

Unlike standard text processors, speech recognition for dictation outputs session files with audio-linked text. With a session file loaded into an appropriate read and/or write software application, the user may select text, playback the associated audio, modify the text, and save the text-modified session file. Other speech and language processing applications may process or output audio or text, such as command and control (voice activation), text-based or phoneme-based audio mining (word spotting), speaker recognition, text to speech, phonetic generation, natural language understanding, and machine translation. The various speech and language applications frequently use common or similar representational models and software algorithms. See, e.g., Lawrence Rabiner Biing-Hwang Juang, Fundamentals of Speech Recognition (1993), Xuedong Huang, Alex Acero, Hsiao-Wuen Hon, Spoken Language Processing (2001), Daniel Jurafsky & James H. Martin, Speech and Language Processing (2000). Speech and language technologies use pattern recognition approaches found in a variety of applications, such as data capture, boundary definition, elimination of unneeded data, feature extraction, comparison with stored representational models, and conversion, analysis, or interpretation of extracted features. Pattern recognition programs may include handwriting and optical character recognition, counterfeit bill, coin, or check detection, biometric analysis (e.g., such as facial imaging processing), and computer-aided medical diagnosis. See, e.g., Andrew R. Webb, Statistical Pattern Recognition (2nd ed. 2002).

There is an increasing use of speech recognition and other automated speech and language and pattern recognition processing. Given this development, there is a need for a universal session file to lock or otherwise protect session files associated with these processes.

### SUMMARY OF DISCLOSURE

The present disclosure teaches various inventions that address, in part or in whole, this and other various needs in the art. Those of ordinary skill in the art to which the inventions pertain, having the present disclosure before them will also come to realize that the inventions disclosed herein may address needs not explicitly identified in the present application. Those skilled in the art may also recognize that the principles disclosed may be applied to a wide variety of techniques involving data interpretation, analysis, or conversion by human operators, computerized systems, or both.

As previously disclosed in '671 and other copending applications, a session file may be produced by manual methods, automated pattern recognition such as speech and language processing, or both.

In one approach, the process of session file creation begins with capture and division of boundary division of audio, text, image, or other data input. This is followed by processing of the bounded data input, and output of a session file associating bounded input data to text, audio, image or other output. Boundary division may consist of a plurality of segments for audio or text data input representing a segmented stream of characters or binary audio data, two-dimensional areas for digital photo, graphics, or other image data (e.g., defined by pixels), or volumes or spaces for three or more dimensional data. After creation of session files by manual or automated processes, the output may be modified by addition, substitution, deletion, or modification of content by a human reviewer or automated postprocessing. This process may result in a complex, multilayered electronic session file with input and output data elements associated to one or more bounded divisions.

In a related approach, an “empty” session file may initially consist of “empty” bounded divisions containing no data elements. Audio, text, image, and other data elements may be added by manual or automatic processes, or both, to add content and create a completed session file document.

In one approach, session files produced by manual or automatic methods may use a proprietary “.SES” format. This format may use Extensible Markup Language (XML) for organization and recording of markup of the original segmented data in a session file document with structured information, instructions, and history about the file content. This file content may consist of data elements such as audio, text, or images. The process of .SES formation and modification may involve use of a computer desktop application, offline server-based software, or both.

The current disclosure further teaches use of a desktop application such as an exemplary session file editor that supports read and/or write of a session file, as has been previously disclosed in '671 and copending applications. The session file editor may use Hypertext Markup Language (HTML) for display and Extensible Markup Language (XML) for organization and recording of markup of the original segmented data. In one approach, the editor may read and/or write generally known file formats like .RTF, .TXT, and .HTML, support Unicode, and also read and/or write the proprietary format .SES.

The session file editor may include a main window with menu and toolbar items for opening, viewing, modifying, and saving files and viewing user documentation. The main window may also have menu and toolbar items for plugins that load with the main application. These plugin applications may include speech recognition, text to speech, machine translation, other speech and language processing, and other pattern recognition. These plugins may be used to create .SES session files directly. The plugins may also be used to create .SES session files by outputting session files that may be converted to .SES format, or by creating audio, text, or image data that may be added to the markup of the original .SES file.

The session file editor may also include one or more document windows for read and/or write of session files and other compatible files, and an annotation window for one or more text and audio annotations (comments) associated to each segment. One or more persons may complete each annotation with an annotation identifier associated to each comment. The text annotation window may also be used to create a dynamic universal resource locator (URL), dynamic file path, or command line to link to websites, open files, or launch programs, including media players.

Among other features, the exemplary session file editor may be used to read and/or write data elements such as audio, text, and images, compare synchronized and other session files in two or more document windows, synchronize asynchronized session files with resegmenting and retagging, create session files for distribution to end users as documents or reports (including multimedia with embedded audio-linked text), produce training session or other files for a user profile or other model for speech and language processing or other pattern recognition, and selectively exclude data material from training files. The exemplary session file editor may also be used to modify a session file with annotation using speech recognition or text to speech by selectively swapping document and annotation text or audio, or selectively replacing portions of the audio and associated text within the session file, such that portions of the original audio and text are made inaccessible to users to protect confidentiality, e.g., with a “beep” for deleted audio or “confidential” for deleted text. One such session file editor application is SpeechMax™ (available from Custom Speech USA, Inc., Crown Point, Ind.).

In a related approach, a human operator may use the exemplary session file editor to add audio, text, images, or other data markup to one or more empty session files 205, containing boundary divisions only, to create one or more session files in .SES format with content. For example, a speaker may dictate each sentence separately as a segment audio annotation using the sound recorder functionality of the annotation window to create audio data associated to each segment. The session file editor may also read and/or write .SES session files produced by an offline server application. In one embodiment, a server application (such as SpeechServers™) may process output using a speech recognition and speech and language processing toolkit (such as SweetSpeech™) (both products available from Custom Speech USA, Inc.). The server-generated one or more session files may represent untranscribed session files (segmented audio) for manual transcription, transcribed session files using speech recognition using automated speech-to-text decoding, or other session files.

In a related approach, the session file editor may also create one or more session files with .SES format with direct file conversion of files created from application programs from third-party developers. These third-party applications may include speech recognition, text to speech, or other speech and language processing and pattern recognition. These third-party applications may be incorporated within plugins that load with the exemplary session file editor for desktop use, or integrated with server applications that output files on an automated workflow.

As disclosed in the '671 and copending applications, the third-party applications may include Dragon NaturallySpeaking® (ScanSoft, Inc., Peabody, Mass., now Nuance Communications, Inc.), IBM ViaVoice® (IBM, Armonk, N.Y.), Philips® SpeechMagic® (Vienna, Austria) for speech recognition for dictation, Microsoft® Speech Software Development Kit (Microsoft Corporation, Redmond, Wash.) for speech recognition and text to speech (including speech recognition for Windows® Vista™ operating system), AT&T® NaturalVoices® (New York, N.Y.) and NeoSpeech® VoiceText® (Mountain View, Calif.) for text to speech, and other third-party solutions, such as machine translation and other speech and language processing, and other pattern recognition, such as handwriting or optical character recognition or computer-aided medical diagnosis. Typically, integration of applications from third-party providers requires use of a software development kit (SDK) to convert third-party proprietary files into the proprietary read and/or write .SES session files. Consequently, the list of third-party applications provided above is considered to be illustrative and not exhaustive, as the existence of software development kits from different developers can potentially support creation of .SES session files derived from a wide variety of third-party software applications.

To protect the .SES session file and prevent unauthorized editing, a flag (comprising one or more bits) may be added to the session file that indicates whether the session file is locked. The flag may consist of the output of a hash function of a user-specified passkey. When locked, (e.g., the flag is set) the file may be read-only, or, alternatively, limited such that certain menus and toolbar items are disabled, such as “save” or “save as.” In one example, the session file may be unlocked by entering the same passkey used to lock the file. In another example, the software license may result in permanent locking of any session file read by the application if the license has the restrictive, lock feature enabled in it, such as may be developed for a “player,” “reader,” or “viewer” version of the exemplary session file editor. In a related approach, a lock may be applied selectively to each of one or more data elements, such as text, audio, or images, to one or more one or more segments of the session file .SES, to selected sections of the document or session file editor features, and to other read and/or write files that may be processed by the session file editor, such as TXT, RTF, or HTML. The disclosed methods and apparatuses may utilize the techniques and apparatus already disclosed in Applicants' prior, co-pending patent application referenced hereinabove. However, other techniques may be used to capitalize upon these further improvements in the art.

These and other objects and advantages of the present disclosure will be apparent to those of ordinary skill in the art having the present drawings, specifications, and claims before them. It is intended that all such additional systems, methods, features, and advantages be included within this description, be within the scope of the disclosure, and be protected by the accompanying claims.

### BRIEF DESCRIPTION OF THE DRAWINGS

FIGS. 1A, 1B and 1C together comprise a block diagram of an exemplary embodiment of a computer within a system or a system using one or more computers.

FIG. 2 is a flow diagram illustrating an overview of an exemplary embodiment of the general process of locking/unlocking one or more session files.

FIGS. 3A, 3B are diagrams illustrating an exemplary embodiment of session file with data elements text, audio, or images and an empty session file with no data elements.

FIGS. 4A, 4B are diagrams illustrating an overview of an exemplary embodiment of session file modification with locking and unlocking of a session file.

FIG. 5 illustrates an exemplary embodiment of the continuum of data elements, segments, session file, document sections, and application features that may be locked/unlocked.

FIGS. 6A-6N illustrate an exemplary graphical user interface depicting the process of locking and unlocking a session file.

### DETAILED DISCLOSURE

While the present disclosure may be embodied in many different forms, the drawings and discussion are presented with the understanding that the present disclosure is an exemplification of the principles of one or more inventions and is not intended to limit any one of the inventions to the embodiments illustrated.

I. System 100

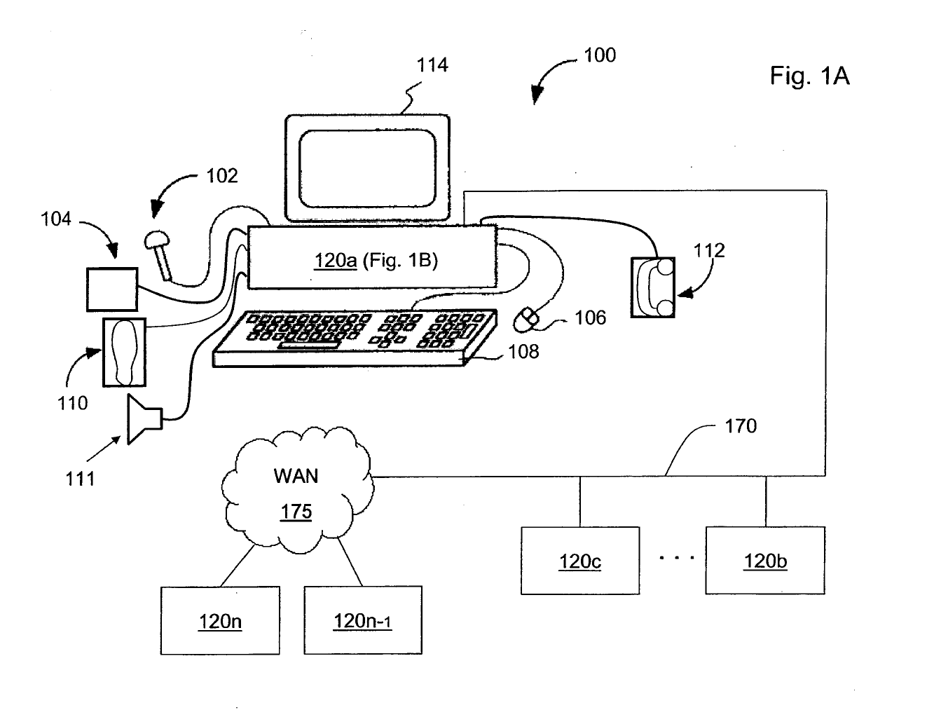

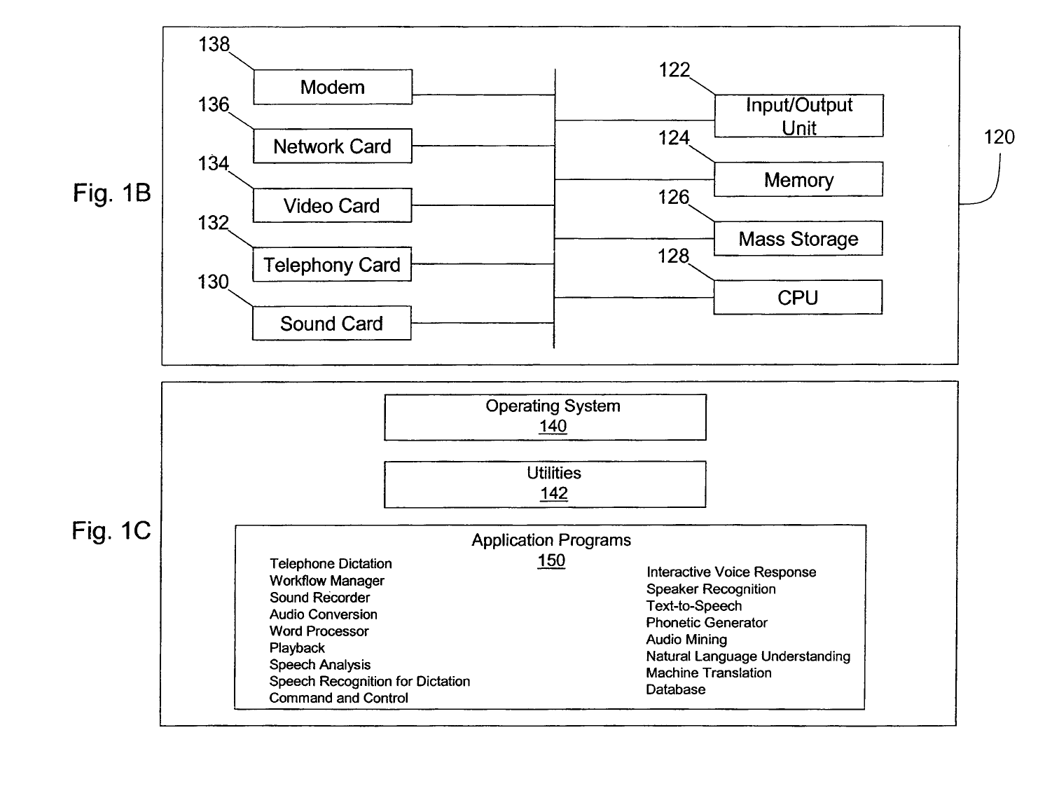

FIGS. 1A, 1B, and 1C together comprise a block diagram of one potential embodiment of a system 100 on which a session file may be written, distributed, read, locked, and/or unlocked. The system may consist of functions performed in serial or in parallel on the same computer 120a or across a local 170 or wide area network 175 distributed on a plurality of computers 120b-120n. The computer 120 may be controlled by the Windows® operating system. It is contemplated, however, that the system 100 would work equally well using a Macintosh® operating system or even another operating system such as Linux, Windows CE, Unix, or a Java® based operating system, to name a few.

Each computer 120 may include input and output (I/O) unit 122, memory 124, mass storage 126, and a central processing unit (CPU) 128. Computer 120 may also include various associated input/output devices, such as a microphone 102 (FIG. 1A), digital recorder 104, mouse 106, keyboard 108, transcriptionist foot pedal 110, audio speaker 111, telephone 112, video monitor 114, sound card 130 (FIG. 1B), telephony card 132, video card 134, network card 136, and modem 138. In one embodiment shown in FIG. 1C, memory 124 and mass storage 126 jointly and operably hold the operating system 140, utilities 142, and application programs 150. The applications programs 150 may include software for a variety of functions, including pattern recognition, speech and language processing, and an exemplary session file editor 160.

The session file editor 160 may be the type disclosed in the '671 application and other copending applications that is a text editor oriented to speech and language processing with support of display of images and graphics. However, it is contemplated that other session file editors may be created to work within the present disclosure. In one approach, the session file editor may read and/or write a session file with RTF, .TXT, .HTML, or proprietary format (.SES). This proprietary format may use Extensible Markup Language (XML). The exemplary graphical user interface is illustrated throughout this patent application within a Windows® Operating System environment as a standalone desktop application. However, this is done solely to exemplify the teachings of the present invention and not limit the invention to use with the Windows® Operating System or as standalone software. For example, the invention may be implemented with other operating systems, as a web-based application that opens in a browser, or as a set of instructions embedded in a computer-processing chip.

Methods or processes in accordance with the various embodiments of the invention may be implemented by computer readable instructions stored in any media that is readable and executable by a computer system. A machine-readable medium having stored thereon instructions, which when executed by a set of processors, may cause the set of processors to perform the methods of the invention. A machine-readable medium may include any mechanism for storing or transmitting information in a form readable by a machine (e.g., a computer). A machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.).

II. Process 200

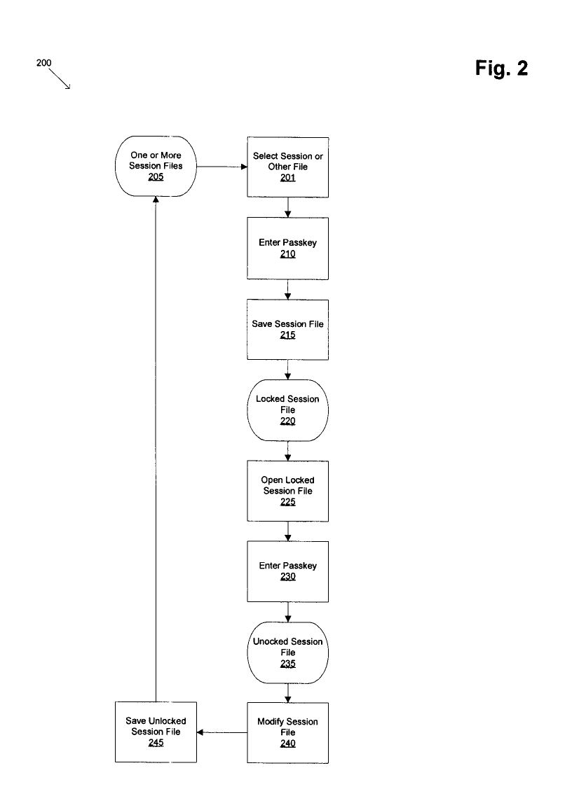

FIG. 2 provides a general overview of the process 200 of modifying a session file by locking and unlocking a plurality of elements of text, audio, image, and other data elements. In one embodiment, the locking and unlocking process affects all session file segments and elements, and disables/enables a predefined set of menu and toolbar items. Those skilled in the art will recognize that the process could be selectively applied to particular data elements, segments, sections, and application features, as predefined by the software or selected by an end user who defines the passkey. The activities may be repeated, order changed, and steps inserted or deleted in actual practice without departing from the spirit and purpose of the invention to protect against unauthorized editing of session file data.

In step 201, the operator may select from one or more session files 205 to open one in a document window of the session file editor 160. In step 210, an operator enters a passkey to set a flag buried in a session file. In step 215, the operator saves the locked session file, thereby creating a locked session file 220. In step 225, an operator opens the locked session file 220 in the document window of the session file editor 160 and, in step 230, enters the passkey to unlock the file, returning the file to its original unlocked status as an unlocked session file 235. Once unlocked, the operator may, in step 240, optionally modify the session file. In step 245, the operator may save the unlocked file. Once unlocked, the session file becomes one or more session files 205 that may be selected for document protection.

Session File

Session files have been previously described in '671 and copending applications. In one approach, the session file (.SES) is binary and zip compressed using techniques well known to those skilled in the art, such as is available with zip compression from various developers. The compacted, binary proprietary session files may be opened and modified in the exemplary session file editor 160.

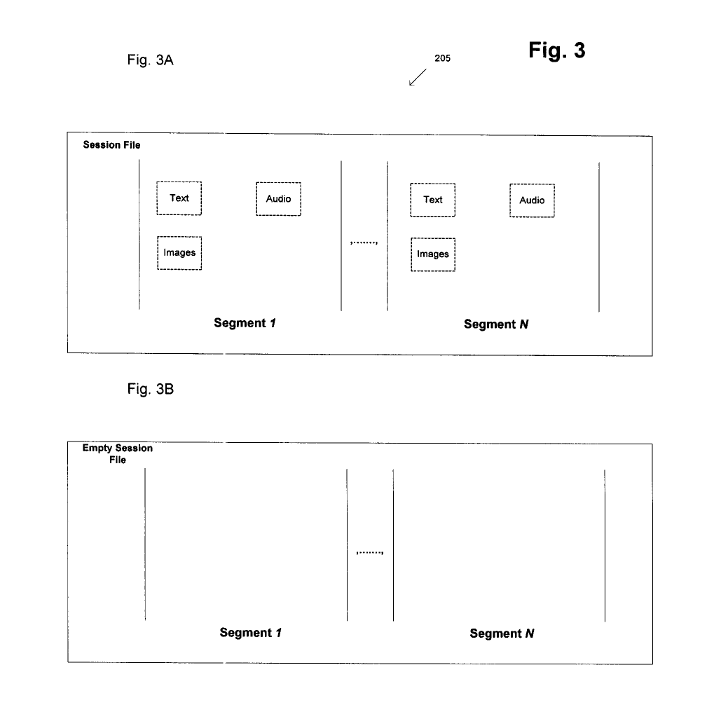

As disclosed in relation to FIG. 3A, the one or more session files 205 may consist of a plurality of 1 through N segments, each with content consisting of one or more optional text, audio, image, or other data elements. Some segments may have one or more elements, others none. The markup and display of these elements may vary as well. For example, text and audio may be displayed as audio-linked text in a main read and/or write document window. Selecting text may support playback of associated audio. The text and audio may also be entered as one or more annotations in the annotation window. Text annotation may also link to a website, open a file, or use a command line to launch a program. One or more images may be displayed in each of the 1 through N segments as original bounded data or markup. As disclosed in relation to FIG. 3B, an “empty” session file consists of boundary divisions only with no data elements. An empty session file may be used manually or automatically to create a session file with one or more data elements. A data-containing session file and an “empty” session file may have a single segment. Further, data elements may be associated to 1 through N bounded image data with divisions determined by pixels or other definitions of image area, and for 1 through N bounded volumes or spaces for three or more dimensional data.

As disclosed in '671 and co-pending applications, bounded text, audio, image, or other data input may be transformed into one or more session files 205 by one or more human operators, computer applications 150, or both. In one approach, source input may be captured by a sensor (e.g., recorder, scanner, or digital camera). After boundary division and processing by human operator or automated process or both, the result may be one or more session files 205 that align bounded data input to bounded output. The one or more session files 205 may be modified by one or more human operators, computer applications 150, or both. Again various approaches may be used to create the one or more session files 205, many being disclosed in the '671 and copending applications. These may include boundary division, feature extraction, and automated pattern recognition to produce a session file (e.g., with speech recognition for dictation to produce a transcribed session file with audio-linked text). These approaches may also include boundary division with manual processing (e.g., creation of untranscribed session file with automated processing that is transcribed and recorded segment by segment by a human operator to create audio-linked text). These approaches may also include creation of one or more session files 205 with markup of an empty session file 205 originally consisting of boundary divisions only. The markup may consist of addition of one or more data elements, such as text, audio, images, or other data. The session file 205 may be synchronized (equal number of segments) with other session files or unsynchronized (different number of segments). Other processes and techniques may be used for generation of one or more session files 205.

As described in the '671 and other copending patent applications, one or more session files 205 in proprietary .SES format may be created from application software 150 or a session file editor 160 that directly outputs .SES files, or from application software 150 representing third-party products that require conversion into a .SES format. For example, third-party Dragon .DRA session files represent output from third-party application software 150. To open this file in the session file editor 160 requires conversion of the .DRA format to a .SES format. Such techniques are well known to those skilled in the art and may require conversion tools for XML or other components distributed in a software development kit (SDK). The conversion may be performed by the session file editor 160 as a desktop process, or offline by a server to create one or more .SES session files 205 for read and/or write by the session file editor 160. Other third-party application software 150 may be used to create .SES session files 205 after conversion or other postprocessing, such as IBM ViaVoice®, Philips® SpeechMagic®, Microsoft Speech Application Programming Interface (SAPI) 5.x-compatible speech recognition from Microsoft® and other companies, SAPI 5.x-compatible text-to-speech from Microsoft, AT&T® NaturalVoices®, NeoSpeech® VoiceText®, and other companies. Other automated speech and language processing and pattern recognition application software may also be used.

Preferably, a software development kit or other software tools are available that support the direct file-to-file conversion of a third-party proprietary session or other one or more files to a proprietary .SES session file 205. However, assignee of the current invention has previously disclosed methods for creating a session file from Dragon NaturallySpeaking® and other third-party speech recognition solutions that used automated, server-based recording of audio linked to text and associated text. Kahn et al., “System For Permanent Alignment of Text Utterances to Their Associated Audio Utterances,” U.S. Pat. App. 20020152076, filed Oct. 17, 2002. Similar techniques may be used for capture of speech and text in other speech and language processing session files. Further, where file conversion of text, images, or graphics is not available, copy and paste using the operating system, screen shot, screen capture, video capture, and other techniques may be available to obtain content data in a compatible format for markup of one of more session files 205.

Locking/Unlocking Session File Flag

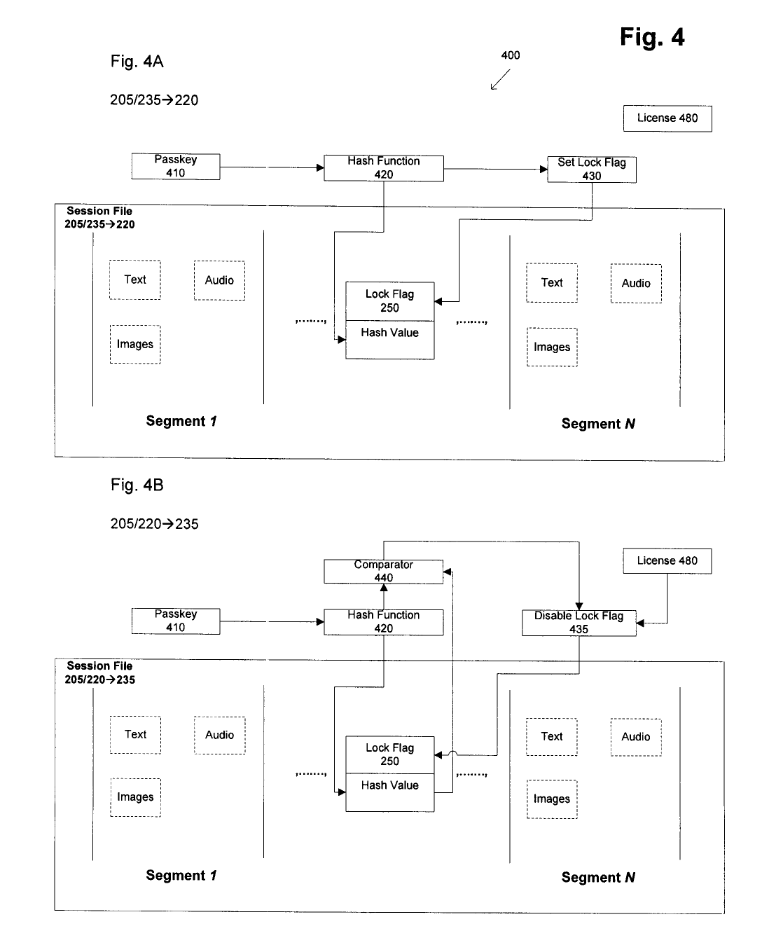

As disclosed in relation to FIGS. 4A and 4B, one or more session files 205 of FIG. 3 may be locked/unlocked using a hash function 420 to create a hash value, a small digital unique identifier derived from any kind of data. A hash function may include a cryptographic hash function, a security hash table, an associative array, and geometric hashing. In one approach, illustrated in FIG. 4A, the process begins with an unlocked session file 235. The user enters a passkey 410 that is processed by a hash function 420. In this approach, the hash function 420 creates a hash value, which is stored within the session file 205 and then triggers the set lock flag step 430 to set a lock flag 250 buried within the now locked session file 220. In this approach, the completion of hash function 420 results in a lock flag 250 being applied to all segments 1 through N of the session file 205 and its content, such as text, audio, or images. In the exemplary approach, the presence of any one of these data elements being embedded is optional. In a related approach, hash function 420, set lock flag 430, lock flag 250 and hash value may also be applied to an empty session file described in relation to FIG. 3B.

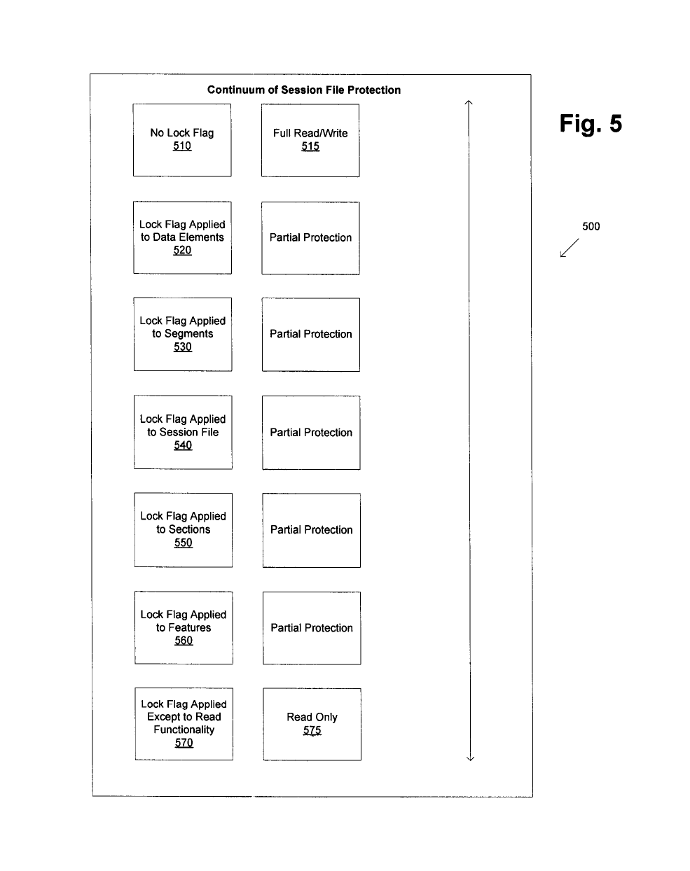

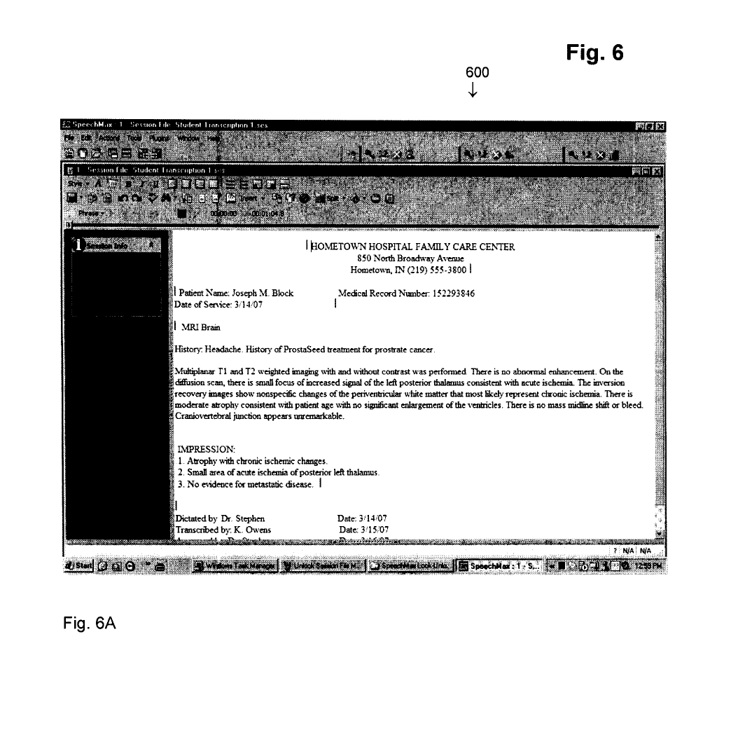

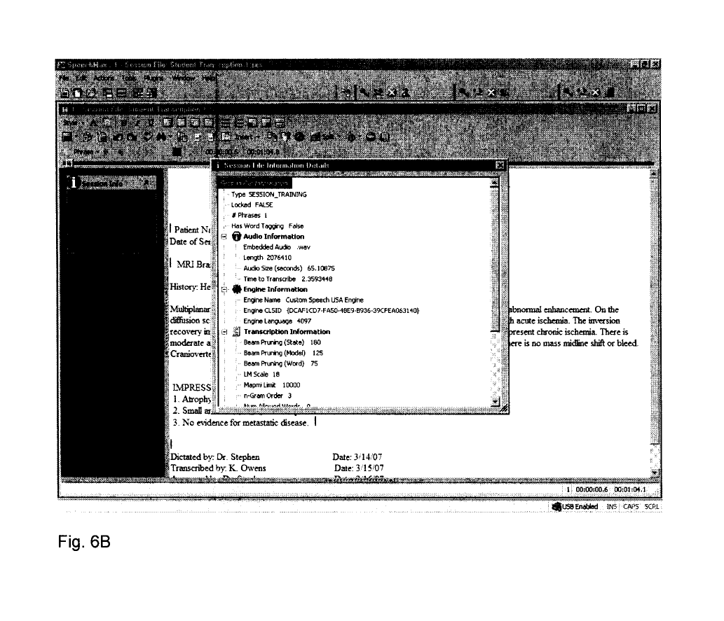

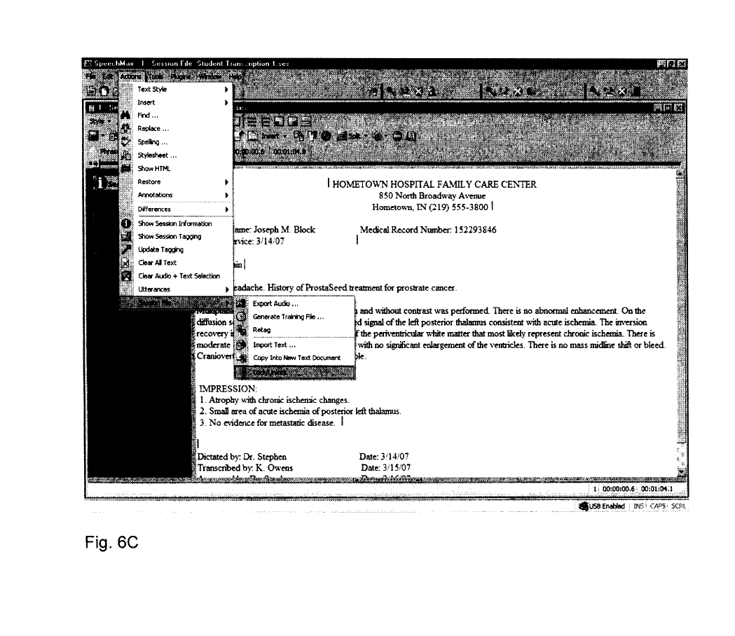

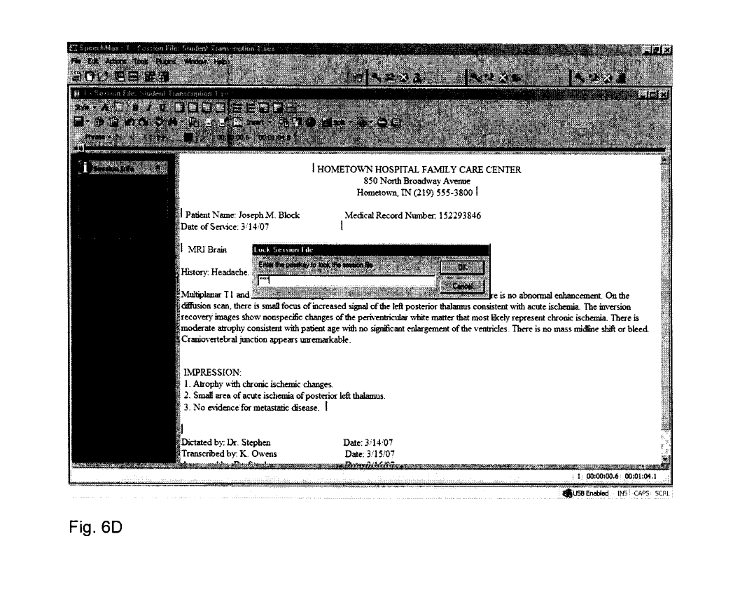

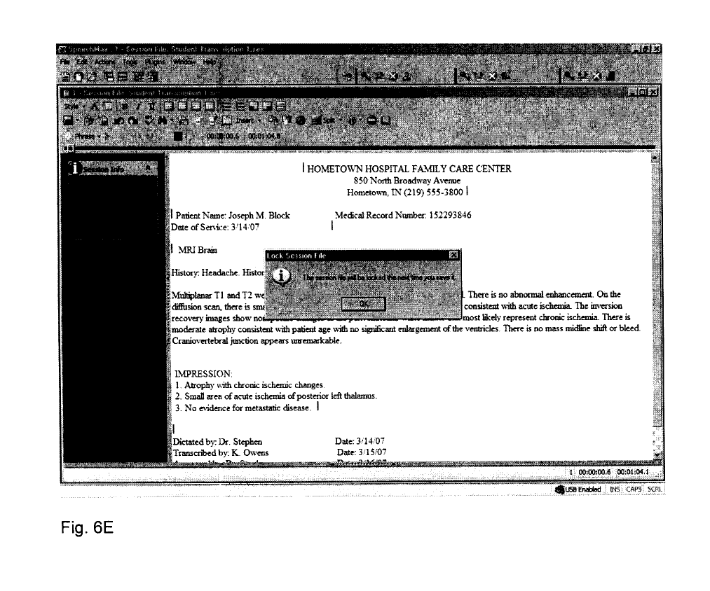

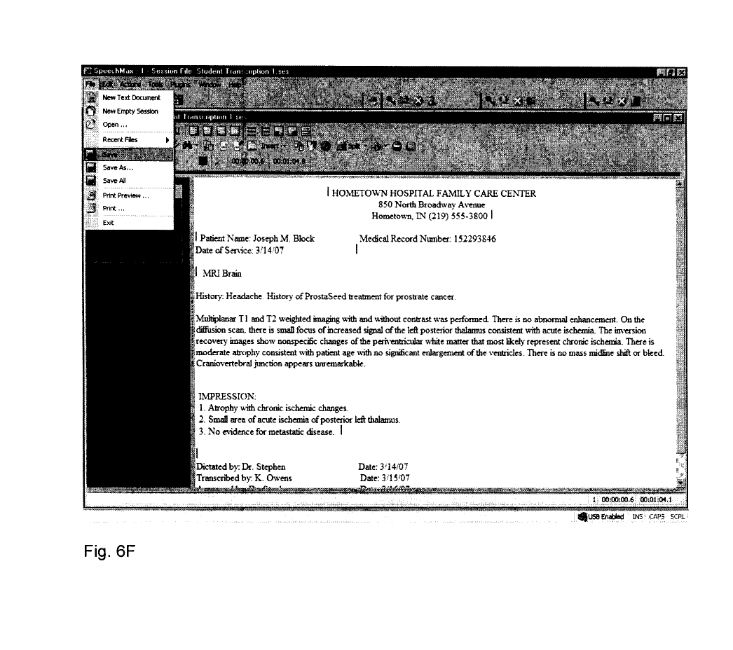

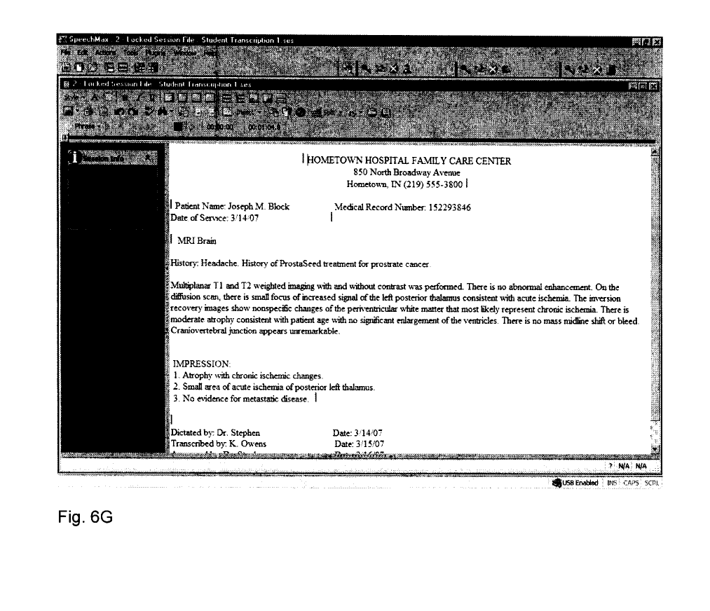

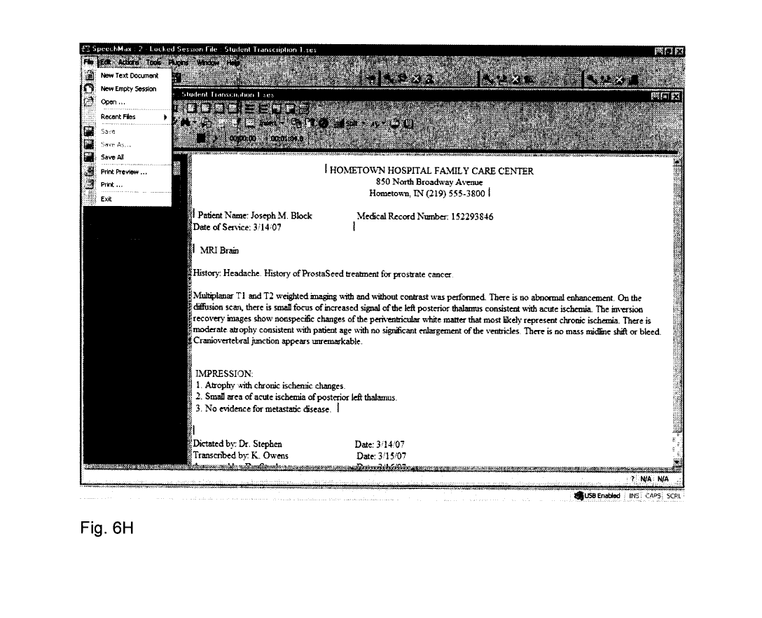

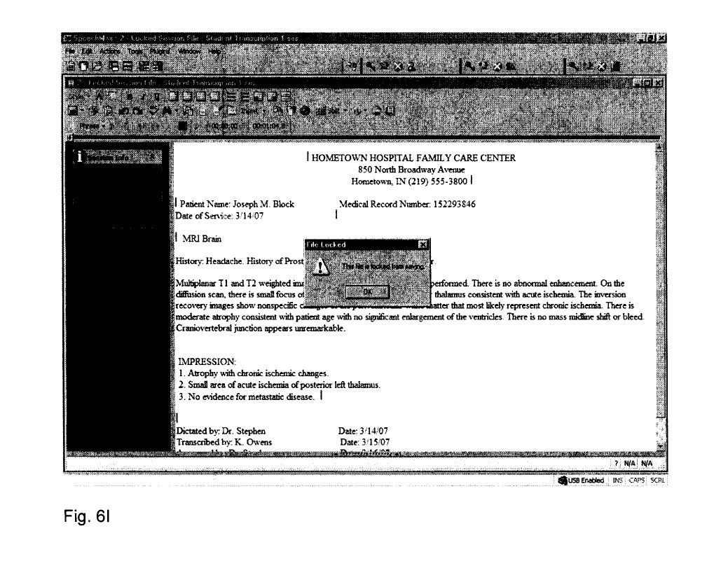

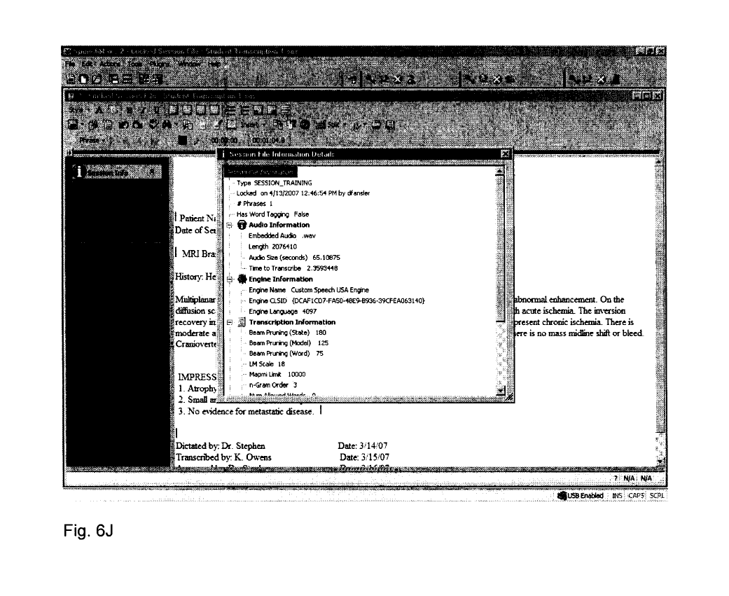

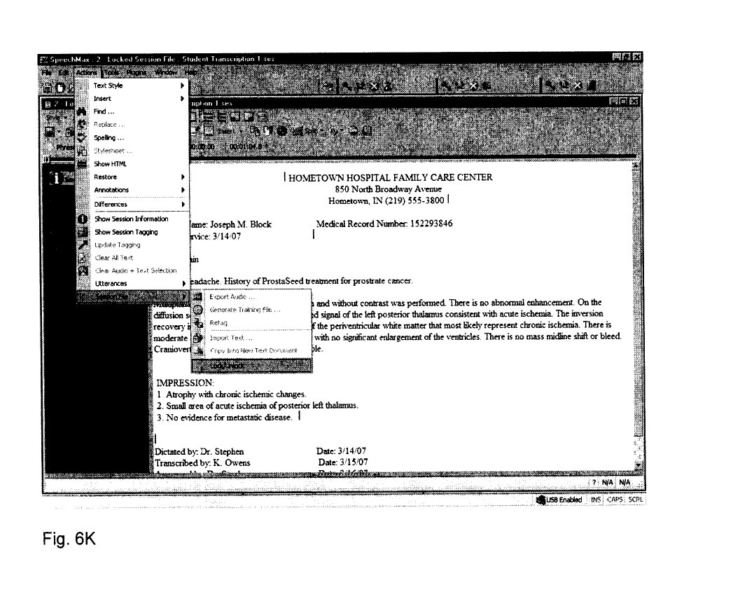

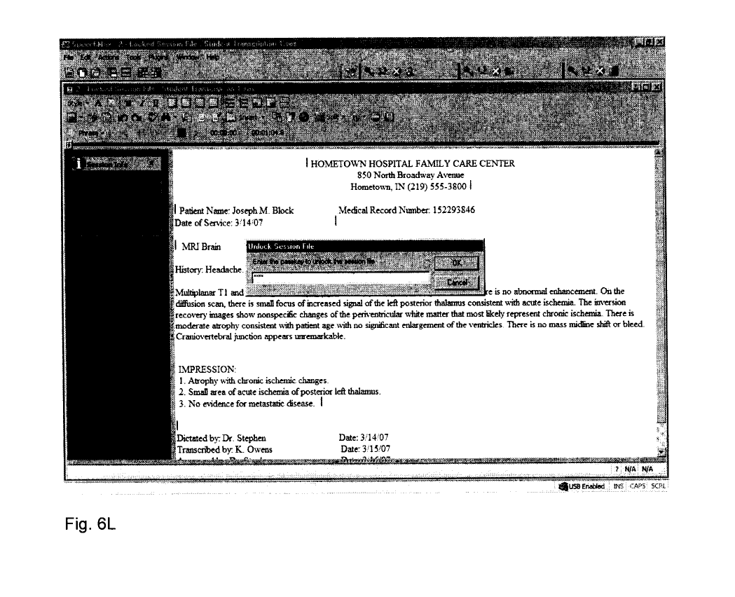

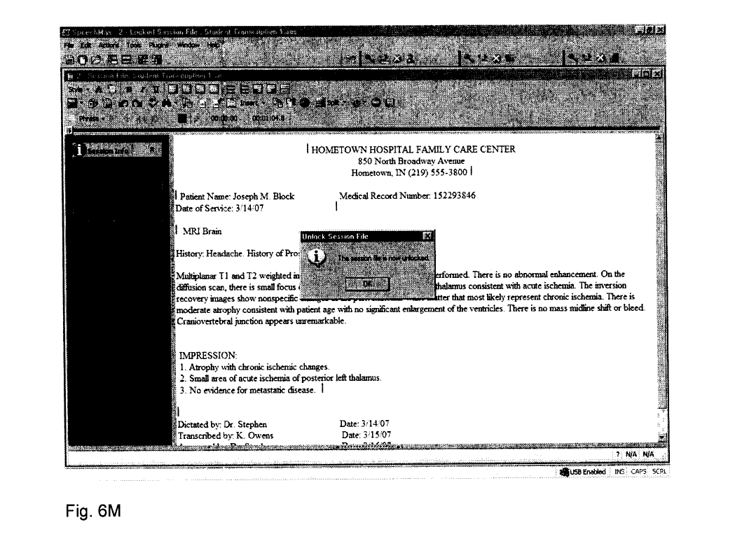

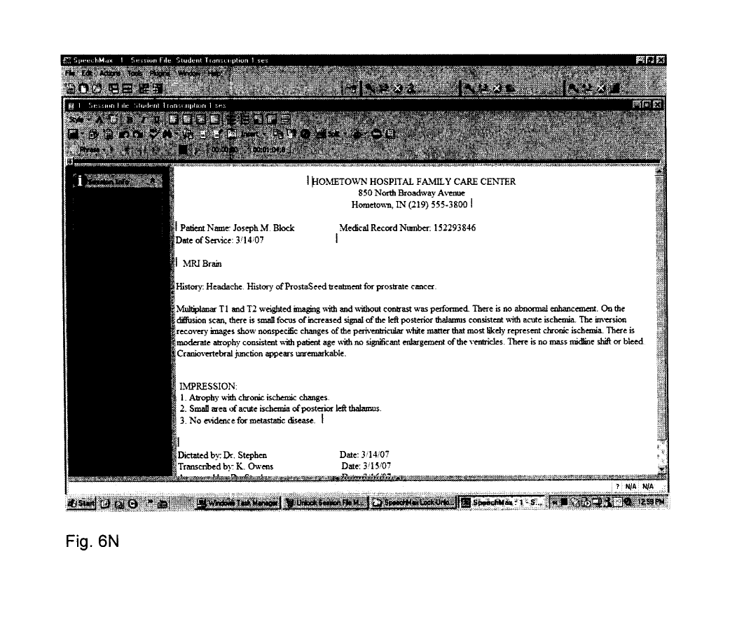

Further, set lock flag 430 may be applied to certain application features, as disclosed in relation to FIGS. 5 and 6. When locked using a passkey 410, session file editor 160 menu and toolbar items may be disabled. These locked features may include save and save as and other similar features, thereby preventing a user from saving a modified .SES session file. Locked features may limit other menu or toolbar items.

The locked session file 220 may be unlocked by opening the session file 225 and entering the passkey 230. In this approach, illustrated in FIG. 4 B, a second user may enter the passkey 410 into a dialog displayed in the session file editor 160. The input passkey may be passed to a comparator function 440 that compares the entry to the hash value previously stored in the locked session file 220. If there is a match, disable the lock flag 435 function normally results in deactivation of the lock flag 250 buried within the locked session file 220. The locked session file 220 is unlocked with all feature use restored as an unlocked session file 235. The user may modify 240 and make and save changes to one or more elements of the session file, such as read and/or write window text, audio, or images, or annotation window text or audio. Save unlocked session file 245 converts it to one or more session files 205 that may undergo the lock/unlock process.

In an alternative approach, use of the exemplary session file editor 106 may also be dependent upon a software license 480. The license bit may prohibit a second user from unlocking the session file 205 whether or not the second user enters the passkey created by the first user. The license bit may be included in the license file for the session file editor 160. This approach would prevent the second user from unlocking the session file whether the user enters the passkey 410 or not.

Lock feature can be applied to any files that may be opened in the exemplary session file editor 160. In one approach, these may include .RTF, .TXT, .HTML, and the one or more session files 205 with proprietary .SES format. Before read and/or write in the exemplary session file editor 160, a .DRA session file and other third-party proprietary files from application software 150 may first be converted to a compatible .SES session file using tools provided in a software development kit (SDK), as disclosed in relation to “Session File” above. This conversion may be performed on a desktop application, such as a plugin loading with the exemplary session file editor 160, or with workflow-based server software application 150.

In one approach, the passkey 410 used to lock/unlock a session file 205 may be applied to one of more document windows of the session file editor 160. As disclosed in relation to the '671 and copending applications, one or more session files 205 produced by manual or automatic means, or both, may be generated in relation to bounded audio, text, image, or other data input. In a related approach, one or more session files 205 that are related could be locked simultaneously with a passkey 410 entered using a dialog accessible from a menu or toolbar item and unlocked by a single user for review. For example, a user might review the original speech recognition session file 205 and resulting translation session file 205.

In a further related approach, a default may be set using the session file editor 160 or offline server application to automatically save one or more session files 205 in .SES format with a lock flag 430. Using techniques well known to those skilled in the art, this may be performed using a known passkey 410 or one automatically generated during the save process for later distribution to one or more one or more selected users.

Other approaches may be used to limit unauthorized modification of one or more session files 205. These may include adding a check sum to the session file, or creation of Meta data and a software application interface that would include a check sum applicable to the one or more session files 205. Other techniques may include use of cyclic redundancy check or pseudorandom numbers.

In one approach, an end user would have an option using the session file editor 160 to save the session file as either an unlocked session file, a locked session file, or both. The option to save the session file as locked or unlocked can be made by dialog box, pull down menu, or selection table. Further, multiple locked and unlocked session files may be created, copied and distributed. In one approach, locked session files may have a different file extension than .SES, such as .USF (“universal session file”) or .PSF (“portable session file”), so that it is apparent that the session file is locked.

Moreover, a basic reader program providing the ability to read, but not write to session files may be distributed. This reader program could be based on the coding of session file editor 160 because the reader program would provide a subset of the functionality of editor 160. In one approach, the reader program could comprise the same code as the editor 160 with the license key permanently set to disable session file editing. In that approach even if the end user knew the passkey 410 associated with the locked session file, the program would not unlock the session file.

Selective Locking/Unlocking Session File Flag

As disclosed in relation to FIG. 5, there is a continuum of features, sections, segments, and data elements that may be locked/unlocked in a session file consisting of segments. FIG. 5 provides an overview of some options. It is not intended to provide an exhaustive list, or to require a particular hierarchy or order in which the set lock flag 430/disable lock flag 435 features may be applied by a session file editor 160 software license 480, other coding affecting the session file editor 160, or optional configuration by an end user. Similar approaches may be used for bounded divisions for images (e.g., pixels) or complex data stored as volumes or spaces.

In one approach, no lock flag 510 may be applied. This results in full read and/or write 515. In another approach, the lock flag may be applied except to read functionality 570, resulting in a read only 575 file.

Alternatively, the lock may be selectively applied to provide partial protection with selective application to data elements 520, segments 530, session file 540, sections 550, or application features 560. Some data elements 520 may consist of text, audio, images, or other data elements and may be identified by file extension or XML description in a session file 205. Lock may apply to some segments 520, for example as identified by segment number or other designation. Further, the lock may apply only to some sections 550 of the session file editor 160, such as main read and/or write document window, but not to text or audio comments created in the annotation window. This would permit the user to add to or modify preexisting comments. In one embodiment, session file editor 160 may also support one or more text and audio annotations per segment, each annotation identified by an annotation identifier. The locked sections 550 may include read and/or write content in one or more read windows, plus annotations (identified by annotation identifier) in the annotation window, thereby permitting the user to add comments to a specific annotation identifier only. Sections 550 may also be defined to reference page number, paragraph number, header and footer, footnote, format (tables, bulleted lists, and number items), and other identifiable document sections. Lock flag may be applied to some features 550, representing functionality available in menu items and toolbars. In one approach, a checklist of features may be provided for selection by an end user.

In one approach, options may be combined. For example, as illustrated in relation to FIG. 6, the lock may also be at the session file 540 level and apply to all data elements 520 and segments 530 within the session file, and the lock may also be applied to some application features 560. In some instances, a lock may be applied to the one or more session files 205 opened in the session file editor, thereby supporting global application of set lock flag 430 to two or more session files 205 for distribution to a single user or a group. This may be of assistance where a single user is assigned the task of reviewing related one or more session files 205, or group users (e.g., trainees, students, or employees) are each assigned the task of reviewing one or more session files 205, as potentially modified by read and/or write changes or text or audio comments made by other users.

Similarly, a license generator application may be deployed that locks some data elements 520, segments 530, session file 540, sections 550, or application features 560 whether or not the end user has a passkey through operation of the software license 480. Further, the license generator application may apply the lock flag except to read functionality 570, thereby creating a license for read only 575 for a player, reader, or viewer version of the session file editor 160.

III. Graphical User Interface: Lock/Unlock of One or More Session Files 205

In one approach, an operator may open a transcribed or other session file 205 in the exemplary session file editor 160. As shown in FIG. 6A, the title bar of the main read and/or write window and document window both display “Session File.” Menu and toolbars for the read and/or write and document windows are displayed. Information about the transcribed session file is available by clicking the “Show Details” item in the left-hand Session Info panel, as shown in FIG. 6B. To lock the session file, the operator may click the Actions menu of the main window, “Session File,” and “Lock/Unlock” (FIG. 6C), enter the passkey to lock the file (FIG. 6D), approve locking the session file during the next save (FIG. 6E), and save as displayed in FIG. 6F.

After the session file has been locked, “Locked Session File” (FIG. 6G) is displayed in the main and document window title bars. The “Save” and “Save As . . . ” menu items are now inactivated in the main window File Menu. When the user clicks “Save All” in the File Menu (FIG. 6H), a dialog appears that the file is locked from saving. FIG. 6I. Session File Information (FIG. 6J) now indicates that the file has been locked. Other features may be locked, as indicated by the grayed out menu Action items in FIG. 6K. The Lock/Unlock menu item remains activated (FIG. 6K), thereby permitting entry of passkey (FIG. 6L) and unlocking of the file (FIG. 6M). After the user saves the file, the file becomes an unlocked (FIG. 6N), identical to the originally created file in FIG. 6A. As before, the title bars of the main and document windows no longer indicate “Locked Session File.”

The graphical user interface of the session file editor 160 may also provide user options to apply set lock flag 430 to data elements 520, segments 530, session file 540, document sections 550, features 560, and except to read functionality 570, or as a global lock to the one or more session files 205 displayed in the one or more document windows of the session file editor 160.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed:

1. An apparatus comprising:
a session file including one or more data elements associated to each of one or more session file bounded divisions;
a session file editor for read and/or write of one or more data elements associated to each of the one or more session file bounded divisions;
a lock/unlock function operably associated with the session file editor supporting user creation of passkey for lock and unlock of a session file;
wherein the lock function limits saving of a modified session file, such that passkey entry is required to save a modified session file in the session file editor.

2. The apparatus according to claim 1 wherein a session file results from conversion of one or more third-party application files.

3. The apparatus according to claim 1 wherein a session file consists of text associated with each audio file of one or more bounded divisions.

4. The apparatus according to claim 1 wherein the session file editor supports read and/or write of text and playback of audio linked to selected text.

5. An apparatus comprising:
a session file including one or more data elements associated to each of one or more session file bounded divisions;
a session file editor for read and/or write of one or more data elements associated to each of the one or more session file bounded divisions;
a lock function operably associated with the license generator of a session file editor;
wherein the lock function limits saving of a modified session file even with entry of a passkey.
